(19) United States
(12) Patent Application Publication
(10) Pub. No.: US 2011/0296694 A1
(43) Pub. Date: Dec. 8, 2011

(54) CLIPPER

(76) Inventor: Hsin-Te HUANG, Taichung (TW)

(21) Appl. No.: 13/152,727

(22) Filed: Jun. 3, 2011

(30) Foreign Application Priority Data
Jun. 4, 2010 (TW) 099118076

(51) Int. Cl. B26B 13/28

(52) U.S. Cl. 30/254

(57) ABSTRACT

A clipper of the present invention includes two clipping members and a connecting portion. Each of the clipping members includes a clipping portion, a pivot portion, and a handle portion, wherein the pivot portion is connected between the clipping portion and the handle portion. The connecting portion includes two slots and two shafts. The two slots respectively disposed in one of the pivot portions. The two shafts are respectively and slidably disposed in the two slots, and fixed to the other one of the pivot portions. So that, the connecting portion is connecting between the two clipping members, and an opening is defined between the two clipping portions. Further, the two clipping members can pivot with respect to each other so as to open or close the opening. And the two slots are unparallel to each other. Thereby, user can cut an object with the clipping portions of the clipper.

### BACKGROUND OF THE INVENTION

1. Field of the Invention

The present invention relates to a clipper.

2. Description of the Prior Art

Conventional clippers are mainly formed with two blades being pivotally disposed to each other. One end of each blade is formed with a handle for users to hold thereon. And the users can hold the handles to pivot the two blades so as to cut objects. There are some other clippers which have a slot on one of the blades and a shaft on the other one of the blades, wherein the shaft is slidably disposed in the slot, so that the clippers allow users to widely pivot the two blades with respect to each other so as to cut the bigger objects. In other words, the shaft can slide in the slot so that the two blades can pivot to widely open. However, the clippers, which are formed with the slot and the shaft, are not convenient to be used because the shaft is prone to be stuck on the edge of the slot or to randomly slide in the slot.

Therefore, the present invention is arisen to obviate or at least mitigate the above mentioned disadvantages.

### SUMMARY OF THE INVENTION

The main object of the present invention is to provide a clipper for users to conveniently cut objects.

To achieve the above and other objects, a clipper of the present invention includes two clipping members and a connecting portion. Each of the clipping members has a clipping portion, a pivot portion, and a handle portion, wherein the pivot portion is connected between the clipping portion and the handle portion. The connecting portion includes two slots and two shafts. The two slots are respectively disposed on one of the two pivot portions. The two shafts are respectively and slidably disposed in the two slots, and are respectively fixed on the other one of the two pivot portions. Consequently, the connecting portion is connected between the two clipping members, and an opening is defined between the two clipping portions, so that the two clipping members can pivot with respect to each other so as to open the opening. And the extending directions of the two slots are unparallel to each other.

Thereby, users can pivot the clipping members of the clipper so as to clip or cut objects. When the two clipping members pivot, the two shafts slide in the two slots, so that the two clipping members can pivot with respect to each other to widely open the opening. Besides, the two shafts can limit the movement of the clipping members in order to avoid the two clipping members or the two shafts from sliding randomly. The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a stereogram showing a clipper of a preferred embodiment in accordance with the present invention;

FIG. 2 is a breakdown showing a clipper of a preferred embodiment in accordance with the present invention;

FIGS. 3-6 are schematic drawings showing a clipper of a preferred embodiment in accordance with the present invention, wherein the clipper is in use;

### DETAILED DESCRIPTION OF THE PREFERRED EMBODIMENTS

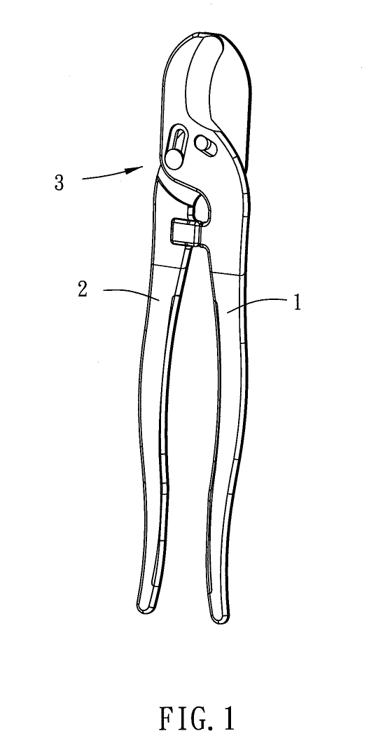

Please refer to FIG. 1. The present invention provides a clipper to cut cables or branches of plants.

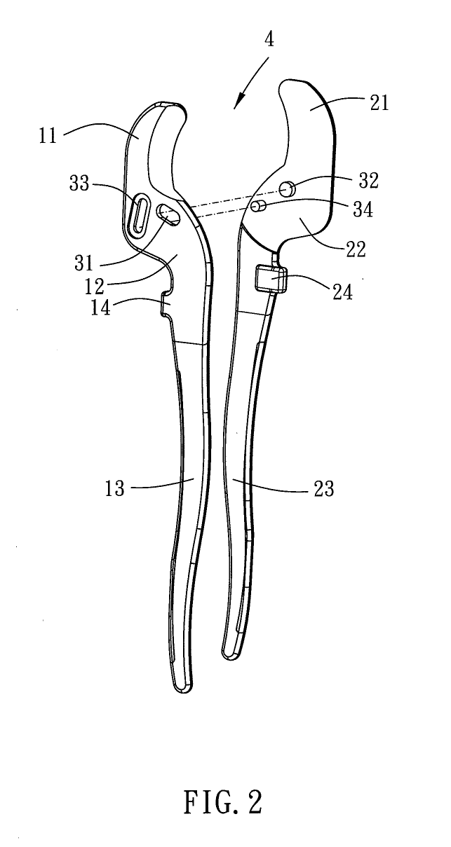

Please refer to FIGS. 1 and 2. The clipper of the present invention includes a first clipping member 1, a second clipping member 2, and a connecting portion 3 which is connected between the first clipping member and the second clipping member.

The first clipping member 1 is formed in one piece and as a long shank. The first clipping member 1 has a first clipping portion 11, a first pivot portion 12 and a first handle portion 13, and the first pivot portion 12 is connected between the first clipping portion 11 and the first handle portion 13. In other possible embodiments, the first clipping member can be assembled by several blocks. The first clipping portion 11 is fixed with a blade, and the first clipping portion is formed as a jaw. Besides, the first handle portion 13 can extend curvedly, or the first handle portion 13 can be disposed with a cover, so that the first handle portion 13 can be held by users. Further, a bump 14 is convexly formed on the first clipping member 1.

The structure and shape of the second clipping member 2 is similar with the first clipping member 1. To be specific, the second clipping member 2 is formed in one piece and as a long shank. The second clipping member 2 has a second clipping portion 21, a second pivot portion 22 and a second handle portion 23, and the second pivot portion 22 is connected between the second clipping portion 21 and the second handle portion 23. In other possible embodiments, the second clipping member can be assembled by several blocks. The second clipping portion 21 is fixed with a blade, and the first and the second clipping portions 11, 21 are respectively formed as a jaw. Besides, the second handle portion 23 can extend curvedly, or the second handle portion 23 can be disposed with a cover, so that the second handle portion 23 can be held by users. Further, an abutting member 24 is convexly formed on the second clipping member 2.

The connecting portion 3 includes a first slot 31, a first shaft 32, a second slot 33, and a second shaft 34. The first slot 31 and the second slot 33 are formed on the first pivot portion 12. The second slot 33 has a first end and a second end. The first shaft 32 and the second shaft 34 are fixed on the second pivot portion 22. The second slot 33 extends straightly, as shown in the FIGS. In other embodiments, the second slot can extend curvedly, wherein the second slot can be formed as any arc or bending shapes between the first and the second ends. The first shaft 32 is slidably disposed in the first slot 31, and the second shaft 34 is slidably disposed in the second slot 33, so that the connecting portion 3 is connected between the first clipping member 1 and the second clipping member 2. An opening 4 is defined between the first clipping portion 11 and the second clipping portion 21. In other embodiments, the positions of the first slot and the first shaft can be switched, and the positions of the second slot and the second shaft can be switched as well. A connecting line between the first and the second ends of the second slot 33 is unparallel to the first slot 31. To be specific, a length direction of the first slot 31 is close to a direction of a connecting line between the first clipping portion 11 and the second clipping portion 21. A direction of the connecting line between the first and the second ends of the second slot 33 is close to a length direction of one of the first handle portion 13 and the second handle portion 23, wherein the “close” means that two directions extend roughly toward a same point, so an angle between the two directions is smaller than 45 degrees.

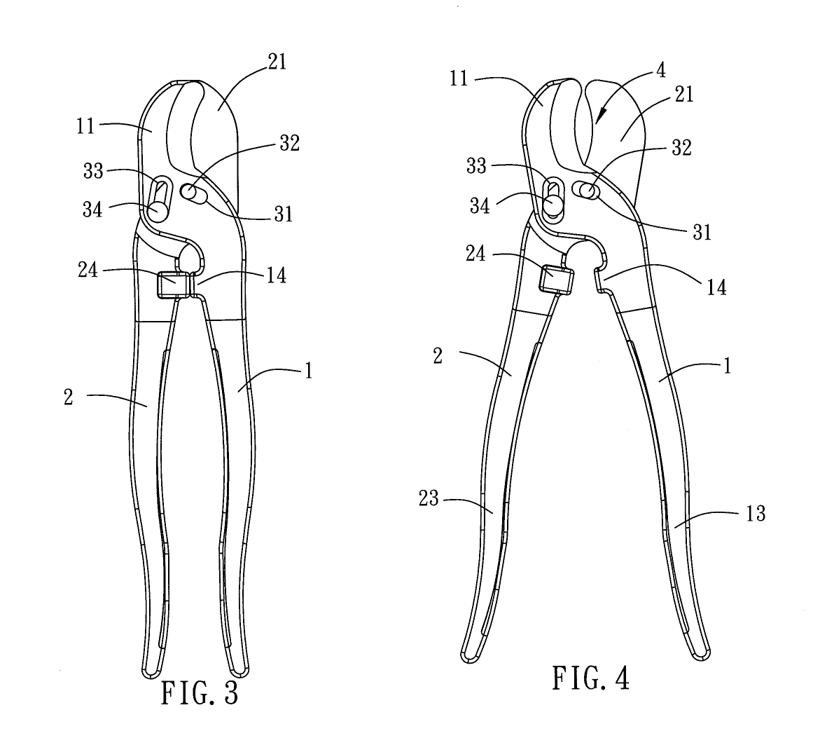

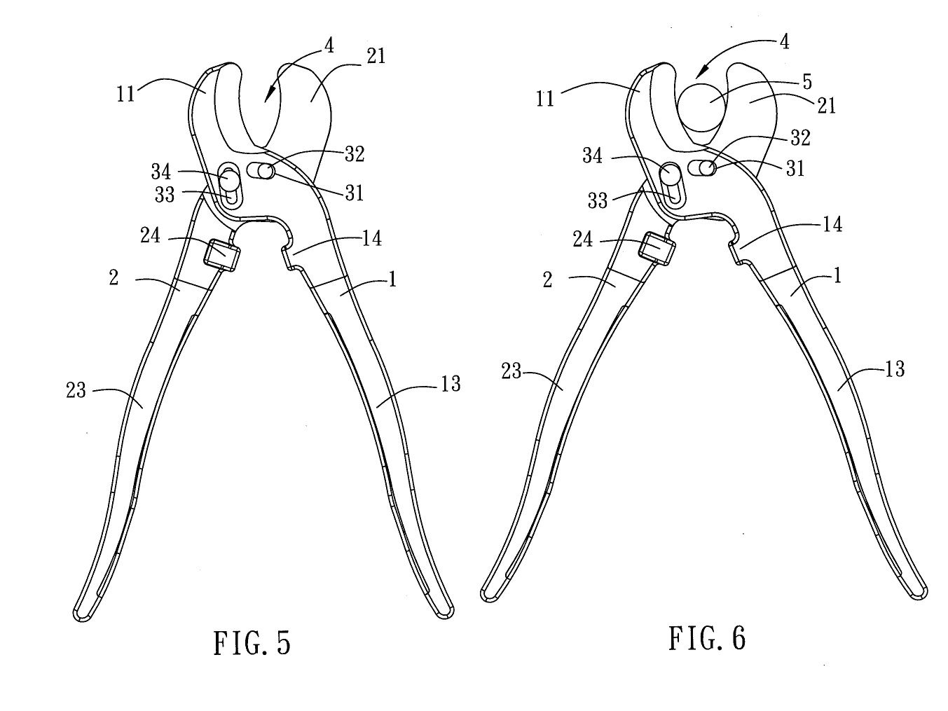

Thereby, the first clipping member 1 and the second clipping member 2 can pivot with respect to each other so as to open the opening 4. Please refer to FIG. 3, the first shaft 32 and the second shaft 34 can be respectively disposed at one end of the first slot 31 and the second slot 33. The first clipping portion 11 and the second clipping portion 21 pivot toward each other so as to close the opening. And the bump 14 of the first clipping portion 11 abuts against the abutting member 24 of the second clipping portion 21. Please refer to FIGS. 4 and 5. The first clipping member 1 can pivot away from the second clipping member 2, so that the first shaft 32 and the second shaft 34 respectively slide in the first slot 31 and the second slot 33 so as to open the opening 4, and make the bump 14 and the abutting member 24 depart from each other. Please refer to FIG. 6, the first shaft 32 and the second shaft 34 can respectively slide to the other end of the first slot 31 and the second slot 33, wherein the first shaft 32 sliding in the first slot 31 can make the first clipping member 1 and the second clipping member 2 slide with respect to each other in order to increase width of the opening 4. Consequently, a user can put an object 5 like branches or cables in the opening, and the user can force to hold the first handle portion 13 and the second handle portion 23 to apply a clipping force, so that the first clipping portion 11 and the second clipping portion 21 pivot toward each other to clip or cut the object. A direction of the clipping force is close to the length direction of the first slot 31 and is also close to a width direction of the second slot 33, so that the second shaft 34 will be a pivot for the clipping force to clip or cut the object 5 thereby. Please refer to FIGS. 4 to 6. When the first clipping portion 11 and the second clipping portion 21 pivot away from each other, the second shaft 34 is located at one end of the second slot 33 which is away from the first handle portion 13 or the second handle portion 23. Therefore, the clipping force is away from the pivot so that its force arm becomes longer and the user can cut the object 5 effortlessly. When the first clipping member 1 and the second clipping member 2 pivot toward each other, the second shaft 34 slides to one end of the second slot 33 which is close to the first handle portion 13 or the second handle portion 23, so that the clipping force is close to the pivot so that its force arm becomes shorter and the user can close the opening rapidly.

In another embodiment, the second slot 33 can extend curvedly, so that one end of the second slot 33, which is close to the first clipping portion 11, bends toward the second clipping portion 21 or the first slot 31. Thereby, the opening 4 can be opened more widely when the first clipping member and the second clipping member pivot with respect to each other.

To sum up, the user can pivot the first clipping member to make the first clipping member and the second clipping member slide with respect to each other, so that the user can widely open the opening. In the same time, the first shaft and the second shaft can limit the sliding movement of each other so as to prevent the first and the second shafts or the first and the second clipping members from sliding randomly. Besides, when the first clipping member pivot with respect to the second clipping member, the second shaft slides toward or away from the first handle portion or the second handle portion so as to change the force arm during cutting. When the opening is wide, the clipper can cut a larger object with a longer force arm; when the opening is narrow, the clipper can cut a small object with a shorter force arm. In other words, the clipper of the present invention can be adjusted to cut different sizes of objects.

What is claimed is:

1. A clipper, comprising:
a first clipping member, comprising a first clipping portion, a first pivot portion and a first handle portion, the first pivot portion being connected between the first clipping portion and the first handle portion;
A second clipping member, comprising a second clipping portion, a second pivot portion and a second handle portion, the second pivot portion being connected between the second clipping portion and the second handle portion;
a connecting portion, comprising a first slot, a first shaft, a second slot, and a second shaft, one of the first pivot portion and the second pivot portion being formed with the first slot, the other one of the first pivot portion and the second pivot portion being fixed with the first shaft, one of the first pivot portion and the second pivot portion being formed with the second slot, the other one of the first pivot portion and the second pivot portion being fixed with the second shaft, the first shaft being slidably disposed in the first slot, the second shaft being slidably disposed in the second slot, an opening being defined between the first clipping portion and the second clipping portion, the first clipping member and the second clipping member can pivot with respect to each other so as to open the opening, the second slot having a first end and a second end, a connecting line between the first end and the second end being unparallel to the first slot.

2. The clipper of claim 1, wherein a length direction of the first slot is close to a direction of a connecting line between the first clipping portion and the second clipping portion, a direction of the connecting line between the first end and the second end is close to a length direction of one of the first handle portion and the second handle portion.

3. The clipper of claim 1, wherein a bump is convexly formed on the first clipping member, an abutting member is convexly formed on the second clipping member, the bump abuts against the abutting member when the first clipping member and the second clipping member pivot toward each other to close the opening.

4. The clipper of claim 2, wherein a bump is convexly formed on the first clipping member, an abutting member is convexly formed on the second clipping member, the bump abuts against the abutting member when the first clipping member and the second clipping member pivot toward each other to close the opening.

5. The clipper of claim 1, wherein the second slot extends curvedly.

6. The clipper of claim 2, wherein the second slot extends curvedly.
